(19) United States
(12) Patent Application Publication
(10) Pub. No.: US 2025/0158346 A1
(43) Pub. Date: May 15, 2025

(54) DEVICE FOR SETTING AN OPTICAL TRANSMISSION

(71) Applicant: Carl Zeiss SMT GmbH, Oberkochen (DE)

(72) Inventors: Martin Hermann, Heidenheim (DE); Conrad Wolke, Aalen (DE); Nils Lundt, Ulm (DE)

(21) Appl. No.: 18/945,059

(22) Filed: Nov. 12, 2024

(30) Foreign Application Priority Data
Nov. 13, 2023 (DE) 102023211214.0

(51) Int. Cl. H01S 3/106; H01S 3/00; H01S 3/10

(52) U.S. Cl. CPC H01S 3/1061; H01S 3/0014; H01S 3/10038

(57) ABSTRACT

A device for setting an optical transmission comprises a first side, a second side and an optical component between the first and second sides. The optical component comprises a first optical element and an adjustment mechanism for moving at least the first optical element. The adjustment mechanism is designed to modify the transmission of the optical component by moving at least the first optical element between the first and second sides such that a light intensity on the second side can be set by the movement of the at least first optical element. The adjustment mechanism is designed to move at least the first optical element such that the optical transmission can be adapted with a switching time of less than 1 s, such as less than 1 ms, for example less than 1 μs. A system comprises such a device and light source that emits light in a beam path.

### CROSS-REFERENCE TO RELATED APPLICATION

This application claims benefit under 35 U.S.C. § 119 to German Application No. 10 2023 211 214.0, filed Nov. 13, 2023. The entire disclosure of this application is incorporated by reference herein.

### FIELD

The present disclosure relates to a device for setting an optical transmission. Furthermore, the disclosure relates to a system comprising a light source that emits light in a beam path, and a device mentioned, and to a method for setting an optical transmission of such a device.

### BACKGROUND

Optical properties of optical components are ideally stable and for example defined by way of their coatings and substrate materials. Systems such as laser beam sources with corresponding optical components may, however, have instabilities in their operation, and so, for example, effects such as drifts of such light sources can occur, especially when the optical components are exposed to unfavorable conditions such as e.g. high light intensity. Corresponding modifications to the optical properties of the radiation from such a light source can lead to undesirable effects and uncertainties in its use for any application.

For example, this can change the power output by light sources, whereby their use for applications can involve a very precise light output setting is no longer possible. Constant conditions are usually desirable when generating light for the exposure of wafers via a lithography machine or for generating light for the exposure of wafers via the light source, and these constant conditions generally cannot be maintained or generally can be maintained only to a limited extent due to light intensity fluctuations. Conventionally, a control of the power of such light sources is realized by way of regulating the energy used for the generation of the light output. For example, should the light source be a laser beam source, a pump power is conventionally regulated to operate the laser such that the emitted light output is adapted to a predetermined light output. However, this can be undesirable because this regulation can be comparatively inaccurate and not suitable for the short-term adjustment of power changes, for example on the order of milliseconds or even nanoseconds.

### SUMMARY

It is desirable to provide of an alternative approach for setting an emitted power of a light source, such as a laser beam source, which overcomes undesirable aspects of certain conventional controls.

The disclosure seeks to provide an improved technique for setting an emitted light output of a light source, which overcomes the aforementioned undesirable aspects of certain is conventional techniques. The disclosure can also allow for improved operation of such a light source.

In accordance with a general aspect, the disclosure relates to a device for setting an optical transmission. The device comprises a first side and a second side, and an optical component arranged between the first side and the second side, the optical component comprising a first optical element. Furthermore, the device comprises an adjustment mechanism for moving at least the first optical element, the adjustment mechanism being designed to modify the transmission of the optical component via a movement of at least the first optical element between the first side and the second side such that a light intensity on the second side can be set via the movement of the at least first optical element. The device is characterized in that the adjustment mechanism is designed to move at least the first optical element such that the optical transmission can be adapted with a switching time of less than 1 s.

In accordance with one embodiment, the light intensity on the second side can be settable to a predetermined value via the movement of the at least first optical element. The predetermined value can be an absolute light intensity or else a relative value. For example, the relative value can correspond to 20%, 40%, 60% or 80% of a light intensity entering the device on the first side. These values should be understood as being purely exemplary. Intermediate values between 0% and 100%, which a person skilled in the art would like to set, are also conceivable and would be chosen according to the application. This can make it possible to set a predetermined optical transmission, and high and lower light intensities can be provided.

Switching time can be understood to mean a time that the adjustment mechanism uses for moving at least the first optical element from a first position to a second position in a non-continuously cyclic movement. This is called discrete switching time. Furthermore, switching time can be understood to mean a time that the adjustment mechanism uses for moving at least the first optical element along a single period of a cyclic continuous movement. This is called periodic switching time.

This can offer a device that can react flexibly and with short switching times or a high frequency to deviations in the input power on the first side or deviations in the output power on the second side, in order thus to adapt transmitted light output through the device such that uniform light output can be provided for any application.

In so doing, the device can allow setting the transmission substantially without light loss or with light loss. Furthermore, the device can set the transmission coarse-mechanically, for example using stepper motors, or fine-mechanically, for example using piezo actuators. The transmission can also be set discretely by virtue of switching from one transmission value to another, or continuously or periodically, for example by way of an oscillation such that repeatedly recurring transmission values are set. For a more detailed explanation, reference is also made to the description of the following embodiments.

Accordingly, in the device, the first side can be designed to face a light source, and the second side can be designed to face away from a light source. In other words, light from a light source can enter the device substantially from the first side and leave the device to the second side. In this case, the optical component can transmit or reflect up to 100% of the incident light, depending on the relative position of the at least first optical element between the first and the second side. The device can be arranged accordingly in a beam path of a light source, such as a 193 nm light source, for example a laser source at 193 nm.

Setting an optical transmission can comprise setting an optical reflectivity. In other words, should absorption of incident light by the device can be able to be neglected, setting an optical transmission can comprise setting an optical reflection.

The optical transmission can be settable with switching times of less than 1 s, 0.5 s, 0.2 s, 0.1 s, 0.01, 0.002 s, 0.001 s, 1 μs and down to 0.1 μs. In an alternative to that or in addition, the optical transmission can be adaptable with a frequency of greater than 500 Hz, 1 kHz, 5 kHz, 50 kHz, 500 kHz, 1 MHz, 5 MHz or 10 MHz and up to 20 MHz.

Further, the device can have a longitudinal axis, with the longitudinal axis corresponding to an optical beam path from the first side to the second side. Setting can also be understood as regulating, wherein closed-loop control comprises a control loop. The short switching times can allow that both the transmitted and the reflected light intensity can be set comparatively quickly therewith to a predetermined virtually arbitrary value, such as to a value between 0% and 100%, without the power output of a light source per se involving regulation. Furthermore, the device can make it possible to be flexibly attached to different light sources in order to regulate their emitted light output.

The device may further be designed to set a transmission for light of wavelength 100 nm to 20 μm, such as 120 to 800 nm, for example 150 to 250 nm, optionally 193 nm or 248 nm. The device, including the optical components of the device, may be designed depending on the wavelength of the incident light and may have coatings that are suitable for the intended wavelength. It is clear to a person skilled in the art that corresponding wavelength specifications are subject to deviations, and a variance of 1 nm around the corresponding wavelength can be possible.

According to one embodiment of the disclosure, the first optical element can have a variable transmission. In this case, the variable transmission can change along a physical extent of the first optical element, and so different points of the optical element have different transmission values. Accordingly, the variable transmission can be a spatially variable transmission. The variable transmission may comprise variable reflectivity, with variable reflectivity acting counter to variable transmission. The sum of reflectivity and transmission can be constant, wherein a precondition for this can be no or only little optical loss. For example, the first optical element can be a mirror, the latter possibly having preset transmission and reflection values by way of coatings.

The variable transmission can allow that by moving the first optical element between the first side and the second side, the transmission can be changed depending on the position where light is incident on the first optical element. For this purpose, the first optical element can be mechanically manipulated. Thus, both discrete switching times, for example via a stepper motor as an adjustment mechanism, and periodic switching times can be realized with this embodiment.

According to a first alternative of the aforementioned embodiment, the first optical element may have the shape of a circular disk. In this case, the variable transmission can vary, for example periodically, in the azimuthal direction of the circular disk. In this case, the variable transmission can be discontinuous and/or not continuously differentiable. For example, abrupt changes in transmission over the circumference of the circular disk are possible. The circular disk can have a securing point for the adjustment mechanism, such as at the center of the disk. This configuration can allow that settings of transmission and reflection values in the region of light incidence on the device can be realized, such as with pulse accuracy, via a, for example fast, rotation of the circular disk and concomitantly periodic switching times. In this context, it should also be stated that it can be assumed even in the case of a drift of the system that successive pulses are similar to each other in terms of their pulse shape (energy vs. time) and the total energy per pulse, and so information from one pulse can be used for the manipulation of a subsequent pulse. According to one embodiment, the circular disk may comprise a plurality of circular disk rings with different spatial distributions of the variable transmission, and so different transmission patterns can be introduced into a beam path of the device by way of a movable axis of rotation of the circular disk. This can allow greater flexibility when setting a transmission through the device.

According to a second alternative of the aforementioned embodiment, the first optical element may have the shape of a polygon. The shape of a polygon can also include polygons having any shape in an area of the polygon, for example a pentagon with a circular cutout within the pentagon. The polygon can have a continuously changing transmission over its extent, from a minimum transmission to a maximum transmission. Further, the polygon can be a rectangle. This alternative can be used to set discrete switching times by virtue of the polygon moving rapidly from a first position to a second position and not performing a rotating, cyclic motion. Alternatively, the polygon can also perform a rotation, for example in accordance with the aforementioned example of a pentagon with a circular cutout.

According to a further embodiment of the disclosure, the adjustment mechanism can be designed to move the first optical element rotationally. This can be used to realize periodic switching times. The axis of rotation of the first optical element can be parallel to a longitudinal axis of the device. The longitudinal axis may correspond to a direction of incidence and/or an emergence direction of the light. In other words, the first side and the first optical element can be arranged such that the light entering the device on the first side impinges on a surface of the first optical element at right angles. The adjustment mechanism can be an electric motor, which is secured to the securing point of the circular disk for rotating the circular disk. The rotational speed of the electric motor can be set, and the electric motor can be operated continuously at the rotational speed, and so for example 250, 500 or 1000 revolutions per second are possible.

The fact that the axis of rotation of the first optical element is parallel to a longitudinal axis of the device can allow that the angle of incidence of the light is equal to an angle of reflection, and hence light can be reflected back into a light source. In this case, the first optical element for example is a flat circular disk or a circular disk with a structured surface, such as for example in the case of a reflector stud, and so an angle of reflection is equal to an angle of incidence even if there is no perfect parallelism between the axis of rotation and the longitudinal axis. The first optical element can also have a different shape, for example be a pentagon or have other polygon-shaped extents.

According to one embodiment, the optical component can furthermore comprise a second optical element, wherein the adjustment mechanism is designed to move the first and the second optical element relative to each other. Relative to each other can comprise modification of a spacing and/or an alignment of the first and the second optical element to each other. In other words, the adjustment mechanism can be designed to move the first and the second optical element relative to each other by way of the movement of at least one of the optical elements. For example, the first and the second optical element can furthermore each be polygonal, for example square or rectangular, and aligned flush with each other.

The embodiment with two optical elements can functionally serve as Fabry-Perot etalon and can allow that a transmission of the device is not decisively determined by the local transmission values of the respective optical element but by the possibility of generating interference by way of a spacing of the two optical elements. Via negative interference due to a spacing of the first and second optical element to each other selected on the basis of the wavelength, the transmission on the second side of the device can be greatly reduced accordingly. Naturally, this can be set for the respective application and on the basis of the wavelength of light that enters the device, the optical properties of the two optical elements and other factors, such as coatings of the optical elements. Appropriate calibration methods are known to a person skilled in the art, for which reason no further details in this regard are given here. This embodiment can be operated with discrete switching times. However, it is also conceivable that it is operated with periodic switching times, depending on the control of the adjustment mechanism.

According to a further embodiment of the disclosure, the adjustment mechanism can comprise a first group of piezo actuators which are designed to align the first and the second optical element plane-parallel to each other. The phrase plane-parallel can refer to facing surfaces of the first and the second optical element. In other words, each of the two optical elements can have a plane, with the piezo actuators of the first group being designed to align the planes parallel to each other. This structure can allow the first group of piezo actuators to be able to enable discrete and/or periodic switching times, wherein these can be selected accordingly for one or the other application and the technical specifications inherent therewith.

In one embodiment, there can be three piezo actuators of the first group. The three piezo actuators can be arranged at a distance from one another, and so there are three points at which a respective piezo actuator of the first group makes contact. This can llow that all the degrees of freedom used to adapt the alignment are thus present. Plane-parallel can also be understood as being flush with each other. The piezo actuators of the first group can also additionally adapt a spacing of the first and the second optical element from each other, but without changing the alignment of the two optical elements to each other. This change in spacing can be implemented accordingly in accordance with discrete switching times or periodic switching times, depending on the control of the adjustment mechanism.

The use of piezo actuators can allow for a very precise settability of the alignment and optionally the spacing of the two optical elements in relation to each other. A very precise settability can be understood to mean that the piezo actuators can set travels of less than 1 nm of the spacing. Furthermore, piezo actuators are comparatively easy to obtain and thus reduce the costs for manufacturing the device.

According to one embodiment, the adjustment mechanism can comprise a second group of piezo actuators. The second group of piezo actuators is designed to adapt a spacing of the first and the second optical element from each other such that the alignment of the first and the second optical element to each other remains. Adapting the distance can be implemented in a nanometer range, such as in fractions of lambda/4 of the wavelength of the light, such as nm, which is incident on the device. For example, the positioning path for adapting the distance can be 10 nm. The distance can be adapted in accordance with a discrete switching time by virtue of a change in the distance from one position to another position being implemented discretely, for example with a switching time of less than 1 s.

Alignment can be understood to mean a plane-parallel arrangement of two surfaces of the first and the second optical element relative to each other. Furthermore, the word alignment may comprise the relative orientation to each other in space, which remains unchanged on account of the change in spacing. The number of piezo actuators in the first and the second group can be the same, for example three each.

The use of two groups of piezo actuators can allow that the task of a parallel alignment of the first and the second optical element can be taken up by the first group of piezo actuators, for example, and the task of varying the spacing of the first and the second optical element from each other can be taken up by the second group of piezo actuators. Accordingly, piezo actuators which have very precise travels with little tolerance can be used for the first group of piezo actuators, whereas designs which allow very fast travels can be used for the piezo actuators of the second group. Overall, this can increase the reliability of the device to precisely set a transmission. Furthermore, a person skilled in the art is aware that even more than two groups of piezo actuators can be used according to one embodiment. In this case, the various groups can be selected and combined according to their technical characteristics by a person skilled in the art, so that the functions of alignment and/or change in spacing, as described above, are fulfilled to the best possible extent.

According to one embodiment of the disclosure, the first optical element can be secured to a receptacle via the first group of piezo actuators, and the second optical element can be secured to the receptacle via the second group of piezo actuators. This can also be referred to as a series circuit of piezo actuators.

This arrangement can allow that an independent movability of the first optical element and the second optical element is rendered possible. In this context, the piezo actuators can each be arranged in a peripheral region of the optical elements such that light can pass through a central region of the optical elements.

In an alternative to the above-described embodiment, the first optical element and the second optical element can be movably connected to each other via the first group of piezo actuators and the second group of piezo actuators. In other words, a respective piezo actuator of the first group with a piezo actuator of the second group can form a connection of the first and the second optical element. This can be referred to as a series connection of piezo actuators. The piezo actuators of the first group and the second group can be mechanically connected to each other accordingly. This can allow for a compact design of the adjustment mechanism, wherein the aforementioned features of the separation of the tasks of setting the alignment and the distance are retained.

According to a further embodiment of the disclosure, the piezo actuators of the first group can have a first effective direction, and the piezo actuators of the second group can have a second effective direction that differs from the first effective direction. The effective directions can accordingly make an angle to each other, with a relative change in the spacing of the first and the second optical element depending on the angle. For example, the effective direction of the first group of piezo actuators can be substantially parallel to a beam path or a longitudinal axis of the device or be perpendicular to a surface of the first and the second optical element, and the effective direction of the second group of piezo actuators can make an angle to the beam path or the longitudinal axis of the device of the first and the second mirror, for example 45°, 60° or 70°.

This can allow that the spacing of the first and the second optical element from each other can be set more accurately because only a portion of the stroke of each piezo actuator of the second group is implemented in the direction of the longitudinal axis of the device in each case, whereby a spacing of the first and the second optical element from each other is manipulated. Furthermore, this further can allow that a tolerance or an error in the accuracy of the travel of the piezo actuators of the second group is transferred only partially into the longitudinal direction of the device and thus the precision of setting the spacing is further increased, wherein, moreover, the hysteresis of the piezo actuators of the second group can be neglected within the scope of setting in this embodiment, and relative changes of the piezo actuators that do not pass through the hysteresis are sufficient for setting the spacing, whereby faster switching is made possible.

According to one embodiment, the piezo actuators of the second group can be crystal oscillators. The crystal oscillators can be synchronized to produce in-phase oscillation. A person skilled in the art is familiar with corresponding methods for synchronizing crystal oscillators. This embodiment is used for periodic switching times for example.

The crystal oscillators can allow for a change in spacing to be set very quickly, wherein the changes in spacing can be realized with frequencies of up to 20 MHz. This can allow that the transmission behavior of the device can be influenced by an appropriate frequency and hence, for example, an adaptation can take place between two pulses of a light source, or else the pulse can be even adapted during a single pulse of a light source.

Accordingly, according to one embodiment of the disclosure, the piezo actuators of the second group can be designed to perform a multiplicity of changes in spacing. This can be understood to mean that the first group of piezo actuators is designed to undertake quasi-static adaptations, and the second group of piezo actuators is designed to undertake dynamic adaptations. In this case, the first group of piezo actuators can be formed from piezo actuators which allow comparatively slow but very precise movements, and the second group of piezo actuators can be formed from piezo actuators whose construction is optimized for a fast movement. This can allow for both a very precise alignment and a very quick change in the spacing.

A further embodiment of the disclosure further discloses that the device can comprise a variable absorber arranged on the second side. The variable absorber can be designed as a circular disk. The circular disk may have segments with different absorption values. The absorption values can change continuously or discretely, such as around the circumference or in the azimuthal direction of the circular disk. For example, the absorption values can range from 1% to 99%. The device can further comprise a second adjustment mechanism for actuating the variable absorber. The second adjustment mechanism can be an electric motor which can be designed as a stepper motor, for example.

According to one embodiment of the disclosure, at least the first optical element can have a coating on at least one surface. This can allow that the optical properties of the optical elements can be adapted therewith. The first and the second optical element can have different coatings. The coatings can be designed to increase the reflectivity of the optical element.

According to one embodiment, the relative movement of the first and the second optical element can comprise an opposite tilt of the first and the second optical element, wherein the tilt axes of the optical elements can run parallel to each other. In this case, the first optical element can generate a beam offset, and the second optical element can generate a beam offset counter to the first optical element. This can allow that there is no overall beam offset of the light transmitted through the device. Furthermore, unlike all other disclosed embodiments in which no absorber is used, this embodiment can be an embodiment with significant intended optical losses, since reflected light is reflected out of the beam path at the optical elements in the event of tilt angles of less than 90°, and the reflected light does not remain within the beam path, like in the other embodiments without an absorber. In this embodiment, both discrete and periodic switching times are possible.

According to one embodiment of the disclosure, the device may further comprise a first sensor arranged on the second side and serving to capture transmitted light on the second side, and a control unit for controlling the adjustment mechanism, which is signal-connected at least to the first sensor and the adjustment mechanism. This can allow controllability of the transmission of the device. Furthermore, the control unit can also be signal-connected to the second adjustment mechanism for actuating the variable absorber.

Further, further optical elements can be arranged between the second side and the optical component, for example the aforementioned absorber and/or an amplifier of a laser system, and so the captured value on the second side of the device can be manipulated via the first sensor of these optical components. This can allow that power densities of the light entering the device can be comparatively low, and the optical components of the device accordingly degrade less quickly.

According to one embodiment, the device may further comprise a second sensor arranged on the first side, signal-connected to the control unit and serving to capture light on the first side reflected by the device. This can allow that a light output of reflected light can be regulated into a light source via the signals from the second sensor.

A further aspect of the present disclosure relates to a system comprising a light source that emits light in a beam path and a device disclosed herein. This also makes it possible to realize the variants and features described above to the same extent, and so reference is made to the explanations given above in this respect.

The device is arranged in the beam path of the light source in such a way that the light emitted from the light source can enter the device on the first side of the device, the device being designed to set, via a movement of the at least first optical element, the light to be transmitted from the light source that emerges on the second side of the device. The setting can be effected to a predetermined value.

The light source and the device can be accordingly connected to each other or can be in optical contact with each other such that a pulse-wise and/or continuous and interference-free entry of light from the light source into the device is possible. For example, the device can be arranged directly on the light source and be fixedly connected to the latter. In an alternative, the light source can guide light to the device via a light guide, and so the device itself is not directly in contact with the light source.

According to one embodiment, the light source can be a laser beam source, such as an excimer laser, with a resonance chamber, which can emit light at a wavelength of 193 nm.

According to one embodiment, the device can be designed to reflect light entering from the light source into the device through the first side back into the light source on the first side at least partly by the at least first optical element. This can be understood to mean that portions of the light are reflected, e.g. 1%, 5%, 10%, 20%, 30, 50%, 60%, 70%, 80%, 90%, 95% or 99% of the light incident on the first side of the device.

This can allow that light output is not converted into heat by absorption but can be returned to the system.

According to one embodiment, the device can be designed to substantially keep constant a light intensity value reflected into the light source by the device. In an alternative to that or in addition, reflectivity on the first side can be kept constant. It is clear to a person skilled in the art that such control uses a sensor to measure the light intensity on the first side and uses these values to be supplied in accordance with closed-loop control which can control adjustment mechanism of the device.

According to a further embodiment, the variable absorber can be designed to reduce a transmitted light intensity on the second side to a predetermined value. In other words, the variable absorber can be designed to reduce light which emerges on the second side from the device to a predetermined value. For this purpose, the variable absorber is arranged in a beam path of the device between the second side and the optical component. The variable absorber can be actuated by way of the second adjustment mechanism via which the absorber can be moved by control signals from the control unit. For example, the variable absorber can be a circular disk or a polygon, for example a rectangle. The variable absorber can have a continuous absorption profile. Alternatively, the absorber can have a plurality of segments with different absorption values. The absorption values can change continuously or discretely, for example around the circumference or in the azimuthal direction of the absorber. For example, the absorption values can range from 1% to 99%.

According to one embodiment, the control unit can be designed to regulate the light emerging on the second side to a predetermined intensity value, depending on the received signals from the first sensor and corresponding control signals to the adjustment mechanism.

According to one embodiment, the control unit can be designed to regulate the light reflected on the first side to a predetermined substantially fixed intensity value depending on the received signals from the second sensor, the transmitted light intensity being reduced to the predetermined value via the variable absorber by virtue of control signals from the control unit positioning the variable absorber accordingly on the second side via a second adjustment mechanism. In this context, the variable absorber can be moved continuously or held at a specific position. In addition to that or in an alternative, the control unit can be designed to regulate, substantially at the same time, a reflection of light on the first side and a transmission of light on the second side.

Another aspect of the present disclosure relates to a method for setting an optical transmission of a device disclosed herein. The method comprises
measuring a light intensity value on the second side of the device,
comparing the measured light intensity value on the second side of the device with a predetermined light intensity target value,
determining a target position of the at least first optical element depending on the comparison of the measured light intensity value and the predetermined light intensity target value, and
adapting an actual position of the at least first optical element to the determined target position of the at least first optical element via the adjustment mechanism such that the measured light intensity value corresponds to the predetermined light intensity target value.

According to one embodiment, measuring a light intensity value on the second side of the device can be implemented via a first sensor for capturing transmitted light on the second side. Furthermore, the steps of comparing, determining and adapting can be implemented via the control unit signal-connected to the adjustment mechanism and the first sensor, by virtue of corresponding signals being transmitted from the first sensor to the control unit and control signals being transmitted from the control unit to the adjustment mechanism. Here, a sampling rate of the first sensor can be defined to be sufficiently quick, with defining the sampling rate being a routine activity for a person skilled in the art. This allows for a light intensity, which is adaptable from pulse to pulse or within a pulse, of the power transmitted through the device.

According to a further embodiment, the method can additionally comprise:
measuring a light intensity value of reflected light on the first side of the device via the second sensor signal-connected to the control unit, the control unit controlling the adjustment mechanism in such a way that a reflected light intensity on the first side is kept constant, and
reducing the transmitted light intensity on the second side via the variable absorber such that the measured light intensity value on the second side corresponds to the predetermined light intensity target value.

In this case, the variable absorber can be signal-connected to the control unit via the second adjustment mechanism and thus be actuated.

Further aspects and exemplary embodiments of the disclosure emerge from the description of the figures below. All combinations of the disclosed features, irrespective of whether or not they are the subject of a claim, lie within the scope of protection of the disclosure.

### BRIEF DESCRIPTION OF THE DRAWINGS

In the figures:

FIG. 1 shows a schematic illustration of a device for setting an optical transmission according to one embodiment;

FIG. 2 shows an exemplary representation of a relationship of transmission and reflection depending on a spacing of two surfaces of the first and second optical element;

FIG. 3 shows a schematic illustration of a device for setting an optical transmission according to one embodiment;

FIG. 4 shows a schematic illustration of a device for setting an optical transmission according to one embodiment;

FIG. 5 shows a schematic illustration of a device for setting an optical transmission according to one embodiment;

FIG. 6 shows a schematic illustration of a device for setting an optical transmission according to one embodiment;

FIG. 7 shows a schematic illustration of one embodiment of a first optical element;

FIG. 8 shows a schematic illustration of one embodiment of a variable absorber;

FIG. 9 shows a schematic illustration of a device for setting an optical transmission according to one embodiment;

FIG. 10 shows a schematic representation of transmission values of an optical element over its extent;

FIG. 11 shows a schematic illustration of a device for setting an optical transmission according to one embodiment;

FIG. 12 shows an exemplary representation of a relationship between transmission and reflection depending on an angle of the embodiment in FIG. 11;

FIG. 13 shows a schematic illustration of a device for setting an optical transmission according to one embodiment;

FIG. 14 shows a schematic structure of a system having a light source and a device; and

FIG. 15 shows a block diagram for illustrating the method for setting an optical transmission of a device.

### DETAILED DESCRIPTION OF THE DISCLOSURE

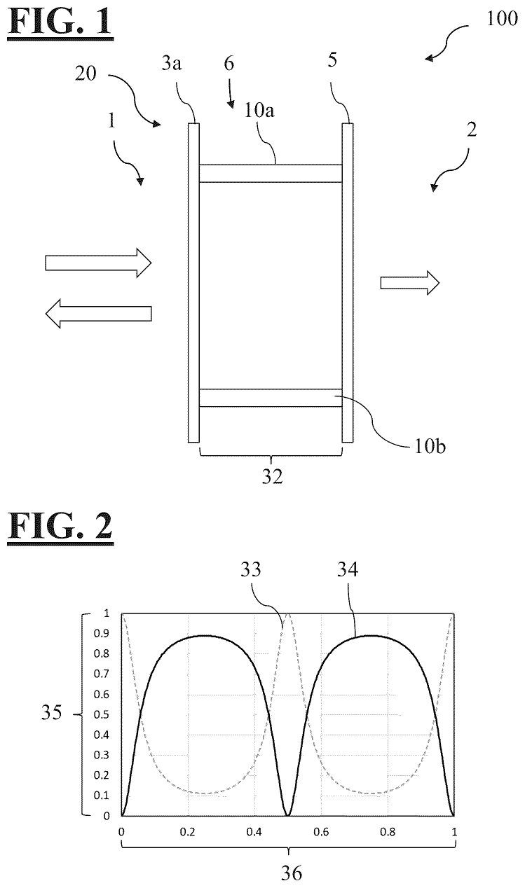

FIG. 1 shows a schematic illustration of a device 100 for setting an optical transmission according to one embodiment. The device shown comprises an optical component 20 having a first optical element 3a and a second optical element 5, which are arranged with a spacing 32 from each other. The adjustment mechanism 6 comprising piezo actuators 10a and 10b movably connects the first and the second optical element 3a, 5 to each other. In this illustration, two piezo actuators 10a, 10b are shown by way of example. However, there may also be three or more piezo actuators that connect the optical elements 3a, 5 to each other.

The optical component 20 having the first optical element 3a and the second optical element 5 is arranged between a first side 1 and a second side 2. The device 100 is designed to allow light to enter the device 100 on the first side 1 (shown here by the arrows on the first side 1) and at least partially leave the device again on the second side 2, depending on how the device is set.

The adjustment mechanism 6 is designed to modify the transmission of the optical component 20 via a movement of at least the first optical element 3a between the first side 1 and the second side 2 such that a light intensity on the second side 2 can be set via the movement of the at least first optical element 3a. In the exemplary embodiment shown in FIG. 1, the piezo actuators 10a, 10b can modify the relative spacing 32 of the first and the second optical element 3a, 5 between the first and the second side 1, 2 and set the orientation, i.e. the parallelism of the first and the second optical element 3a, 5 to each other. Destructive interference can be set by modifying the spacing 32 and on the basis of the wavelength of the incident light, and a transmission from the first side 1 to the second side 2 can be regulated therewith.

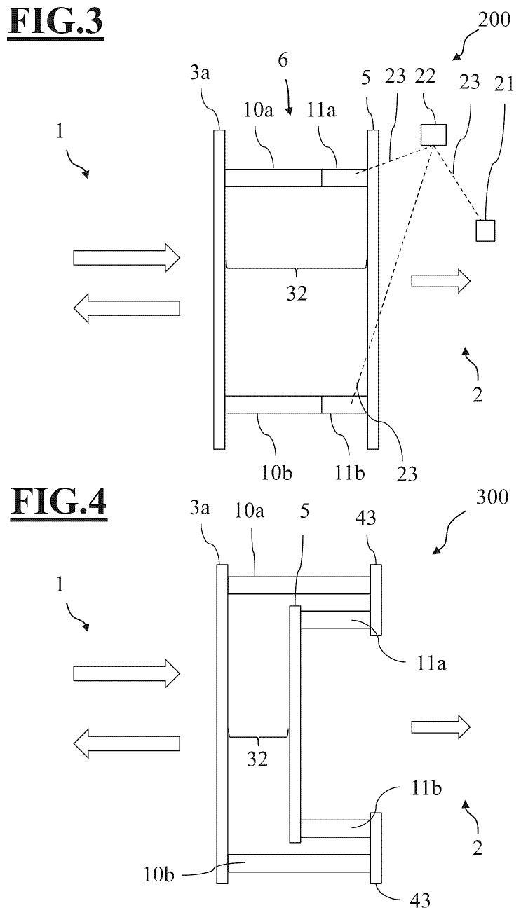

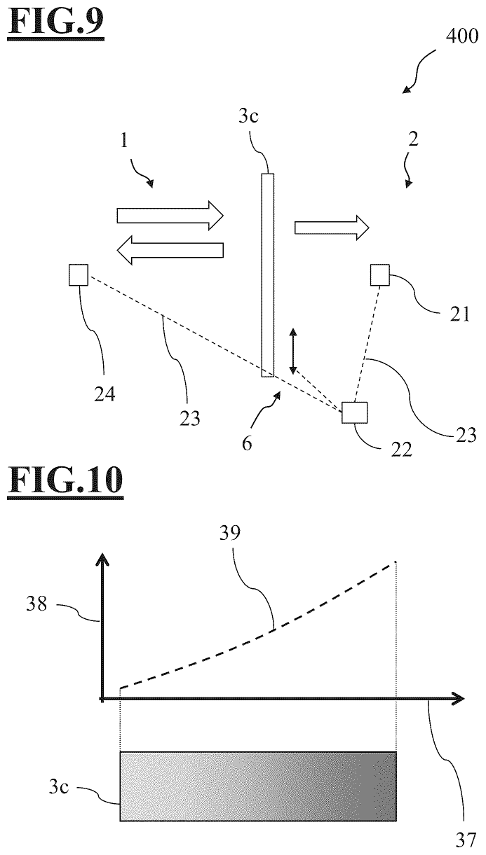

The illustrated device 100 is characterized in that the adjustment mechanism 6 having the piezo actuators 10a, 10b is designed to move at least the first optical element 3a such that the optical transmission is adaptable. The piezo actuators 10a, 10b can be controlled accordingly to this end. The control can be effected coordinated with pulses of a light source, which can radiate light into the device on the first side 1. In this example, the illustration of the sensor systems and control mechanism was omitted. However, a person skilled in the art is aware of how such closed-loop control can be designed from the prior art. Further, reference is made to the description of the exemplary embodiments in FIGS. 3 and 9, in which corresponding control technology is illustrated schematically and which can also correspondingly find use in this example.

FIG. 2 shows an exemplary representation of a relationship between transmission 33 and reflection 34 depending on a spacing 32 of two surfaces of the first and second optical element 3a, 5 of a device 100 (see FIG. 1). The abscissa 36 plots the relative spacing of the first and second optical element 3a, 5 as a function of the wavelength of the incident light. The spacing 32 corresponds to the value 1 on the abscissa, if it has an integer multiple of the wavelength of the light entering the device. Then the transmission 33 on the ordinate corresponds almost to the value 1 or 100%, and a maximum amount of light is transmitted through the device 100. If the spacing 32 is shifted such that lambda/4 is additionally added to or subtracted from an integer multiple of the wavelength of the light entering the device 100, the transmission 33 falls to a minimum at values of about 0.25 or 0.75 on the abscissa. The transmission 33 of the device 100 can thus be set via a relative shift of the first and the second optical element 3a, 5 to each other and hence an adaptation of the spacing 32. Conversely, the reflectivity 34, which is inversely related to the transmission 33, can thus also be set. The reflection 34 is shown schematically on the first side 1 in FIG. 1 as an arrow pointing away from the device 100.

This structure allows that the transmission of the device 100 can be set and light output not required on the second side 2 can be reflected back into a light source, and hence the degradation of both the device 100 itself and other optical elements optically downstream of the device 100 (not shown) is reduced.

FIG. 3 shows a schematic illustration of a device 200 for setting an optical transmission according to one embodiment. In addition to the structure of the device 100 from FIG. 1, the adjustment mechanism 6 of the device 200 comprises a second group of piezo actuators 11a, 11b which are designed to adapt a spacing 32 of the first and the second optical element 3a; 5 from each other such that the alignment of the first and the second optical element 3a, 5 to each other remains. In the embodiment depicted in FIG. 3, the first optical element 3a and the second optical element 5 are movably connected to each other via the first group of piezo actuators 10a, 10b and the second group of piezo actuators 11a, 11b.

This structure allows that the piezo actuators 10a, 10b can be optimized to set the alignment, in other words the plane parallelism, of the first and the second optical element 3a, 5 to each other very precisely, and the piezo actuators 11a, 11b can be optimized to allow a quick change of the spacing 32. For example, the piezo actuators 11a, 11b of the second group can be crystal oscillators. These allow for being able to make very fast changes.

Further, the exemplary embodiment shown in FIG. 3 comprises a first sensor 21 arranged on the second side 2 and serving to capture transmitted light on the second side 2, and a control unit 22 for controlling the adjustment mechanism 6. The control unit is signal-connected 23 to the first sensor 21 and the adjustment mechanism 6. Thus, the adjustment mechanism 6 having the first and the second group of piezo actuators 10a, 10b, 11a, 11b can be controlled by the control unit on the basis of the signals received from the first sensor 21. Thus, the control unit can regulate the alignment of the first and the second optical element 3a, 5 until they are aligned plane-parallel to each other, and the control unit can regulate the changes in spacing of the first and the second optical element 3a, 5 to each other. The illustration of the described components is intended to be purely exemplary and schematic. A person skilled in the art is aware of corresponding components. To avoid repetition, reference is furthermore made to the explanations in relation to FIGS. 1 and 2.

FIG. 4 shows a schematic illustration of a device 300 for setting an optical transmission according to one embodiment. In this embodiment, which is an alternative to the one shown in FIG. 3, the first optical element 3a is secured to a receptacle 43 via the first group of piezo actuators 10a, 10b, and the second optical element 5 is secured to the receptacle 43 via the second group of piezo actuators 11a, 11b. Otherwise, the functionality corresponds to that of the embodiment in FIG. 3, even though the control unit 22, the first sensor 21 and the signal connections 23, which are also to be considered disclosed for the device 300, are not shown in this example. Accordingly, to avoid repetition, reference is made to the explanations given above.

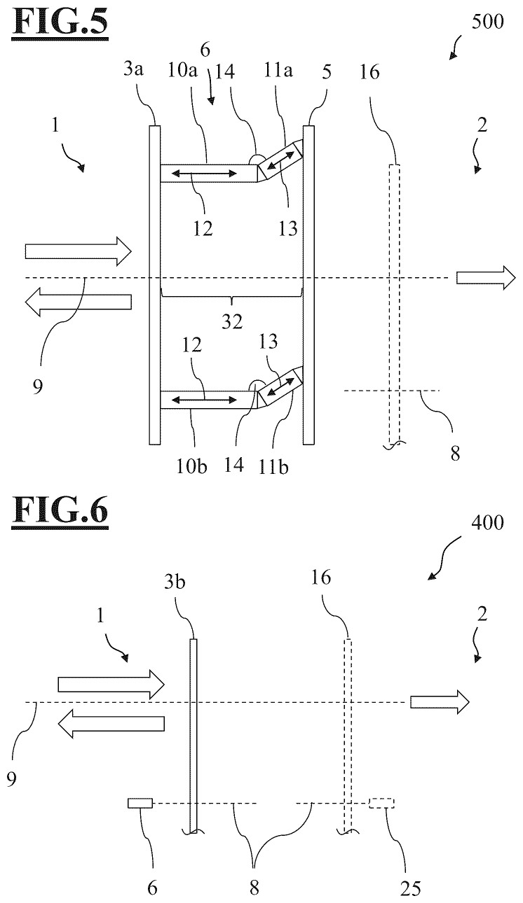

FIG. 5 shows a schematic illustration of a device 500 for setting an optical transmission according to one embodiment. Unlike the device 200 in FIG. 3, the device 500 discloses that the piezo actuators 10a, 10b of the first group have a first effective direction 12, and the piezo actuators 11a, 11b of the second group have a second effective direction 13 that differs from the first effective direction 12. The effective directions 12, 13 make an angle 14 to each other, with a relative change in the spacing of the first and the second optical element 3a, 5 depending on the angle 14. This embodiment allows that inaccuracies regarding the travel of the piezo actuators of the second group can be partly compensated therewith, since only portions of the travels of the respective piezo actuator of the second group develop an effect along the longitudinal axis 9 of the device 500. The movement parallel to the longitudinal axis 9 thus becomes larger or smaller, depending on the angle 14. The piezo actuators 11a, 11b of the second group are correspondingly connected to the piezo actuators 10a, 10b of the first group, for example in integrally bonded fashion via a solder connection or via an adhesive connection.

Furthermore, an absorber 16 which can be arranged on the second side 2 of the device 500 is optionally shown in FIG. 5. The absorber 16 shown has the shape of a circular disk which can be rotated on its axis of rotation 8. Other shapes, for example rectangles, are possible. On the second side 2, the absorber 16 enables the reduction of radiation transmitted through the device 500, for example if reflected radiation on the first side 1 should be kept constant but the associated transmitted radiation on the second side 2 would be too strong. For this purpose, both the control unit 22, the first sensor 21, the signal connections 23 and the second sensor shown in FIG. 9 on the first side 1 in the device 500 would be used, but these are not shown at this point in FIG. 5. Reference is again made to the explanations already given above, especially in relation to FIG. 3, in order to avoid repetition.

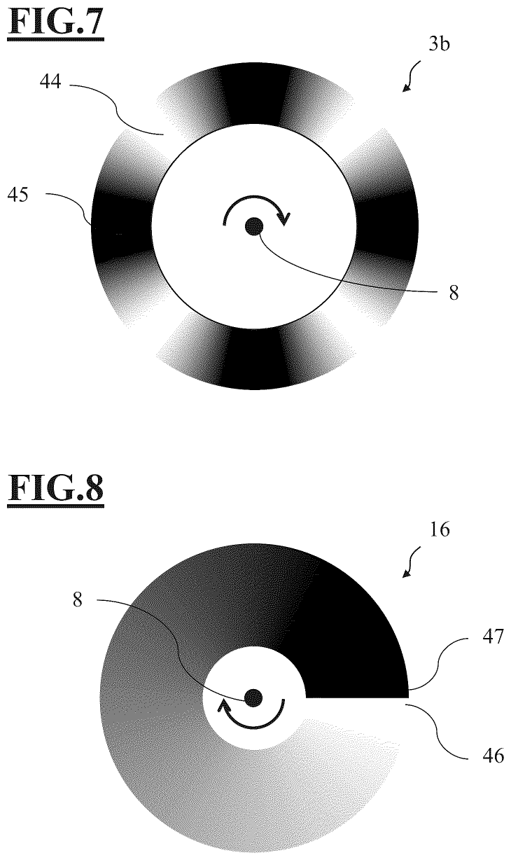

FIG. 6 shows a schematic illustration of a device 400 for setting an optical transmission according to one embodiment. The device 400 comprises a first optical element 3b, which can be actuated via an adjustment mechanism 6, an electric motor in this embodiment. The adjustment mechanism 6 is designed to rotationally move the first optical element 3b, with the axis of rotation 8 of the first optical element 3b being parallel to a longitudinal axis 9 of the device 400. As a result of changing transmission values for the first optical element 3b, the movement thereof can set a transmission from the first side 1 to the second side 2. A more detailed explanation of the first optical element 3b of the device 400 is given in FIG. 7.

Optionally, a variable absorber 16 can also be arranged on the second side 2 of the device 400 in this embodiment in order to allow better settability of the radiation transmitted through the device 400. The absorber 16 can be actuated via a further adjustment mechanism 25 (see FIG. 8 for a more detailed explanation of the absorber 16).

FIG. 7 shows a schematic illustration of one embodiment of a first optical element 3b. In the example shown, four regions with low transmission 45 are arranged on the circular disk. Furthermore, four regions of high transmission 44 are arranged offset from the regions with low transmission 45. The division is intended to be purely exemplary and illustrate the principle. In the example shown, the transitions between the regions 44 and 45 are continuous. Other embodiments, having more than 4 regions each or fewer than 4 regions each are possible and are to be deemed to be disclosed herewith.

The optical element 3b shown has a centrally arranged axis of rotation 8, wherein, for example, an electric motor as an adjustment mechanism can be secured to this axis of rotation 8.

FIG. 8 shows a schematic illustration of one embodiment of a variable absorber 16. The example shown has a continuous profile from a minimum absorption to a maximum absorption. The regions of minimum 46 and maximum 47 absorption are adjacent to each other. Other embodiments are possible. For example, a division into discrete regions with a respective defined absorption is possible. As described in FIG. 7, the variable absorber 16 also has a centrally arranged axis of rotation 8 for securing an adjustment mechanism, for example an electric motor.

FIG. 9 shows a schematic illustration of a device 400 for setting an optical transmission according to one embodiment. The device 400 comprises a first optical element 3c, which has the shape of a rectangle and can be moved between the first and the second side 1, 2 when actuatable via an adjustment mechanism. Further, the device 400 comprises a control unit 22 and a first and a second sensor 21, 24 for capturing transmitted radiation on the second side 2 and for capturing reflected radiation on the first side 1, wherein the control unit is signal-connected to the sensors 21, 24 and the adjustment mechanism 6. The first optical element has a variable transmission, as shown in FIG. 10. This is a particularly simple structure for regulating radiation transmitted through the device 400.

By way of example, FIG. 10 shows a schematic representation of transmission values of an optical element 3c over its extent, as can be applied in a device 400 of FIG. 9, for example. The coordinate system specifies the physical extent of the optical element 3c on the abscissa and transmission or reflection values 38 on the ordinate. The depicted curve 39 shows the location-dependent transmission curve, which runs continuously in this example.

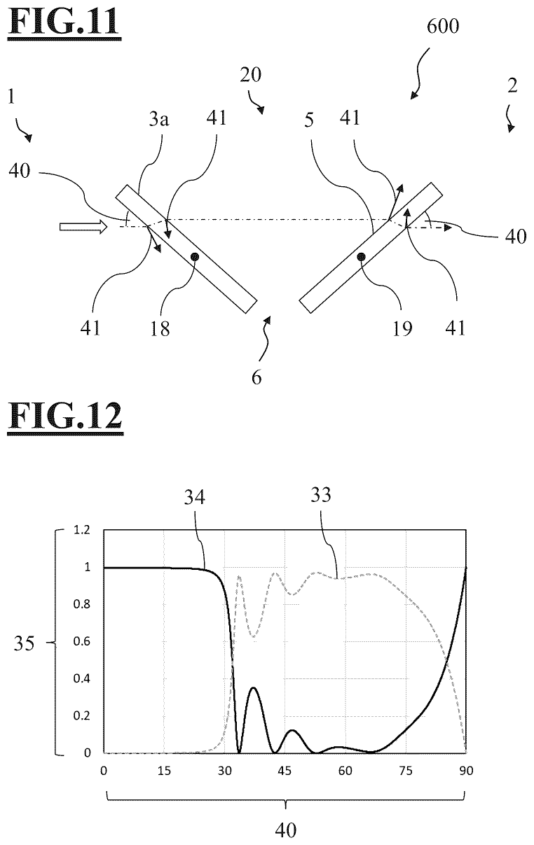

FIG. 11 shows a schematic illustration of a device 600 for setting an optical transmission according to one embodiment. The device 600 comprises an optical component 20 comprising a first optical element 3a and a second optical element 5, which are arranged between a first side 1 and a second side 2. The device further comprises an adjustment mechanism 6 (not depicted explicitly) which is designed to move the first optical element 3a and the second optical element 5 relative to each other. The relative movement of the first and the second optical element 3a, 5 comprises an opposite tilt or else rotation of the first and the second optical element 3a, 5, wherein the tilt axes 18, 19 of the optical elements 3a, 5 run parallel to each other. This ensures that a beam offset due to the first optical element 3a and generated by the tilt through the angle or tilt angle 40 is compensated by the second optical element 5.

This embodiment does not allow the reflection of radiation incident on the first side 1 back into a light source (except at an angle 40 of 90°). Instead, the tilt of the two optical elements generates light losses 41, which are radiated into the environment, at the respective surfaces. Accordingly, this embodiment is one with light losses.

FIG. 12 shows an exemplary representation of a relationship between transmission and reflection 35 depending on an angle 40 of the first and the second optical element 3a, 5 of the embodiment in FIG. 11. The transmission 33 behaves counter to the reflection 34, which are given relatively from 0 to 1 or 0% to 100%. For example, an angle of 90° should be set if no transmission is desired and a maximum reflection back into a light source is intended to be set. A maximum of the transmission 33 is achieved in lower angular ranges, for example 67°. Coatings on the surfaces of the optical elements allow their properties to be set to the individual application. This shall also apply to all embodiments disclosed in this document.

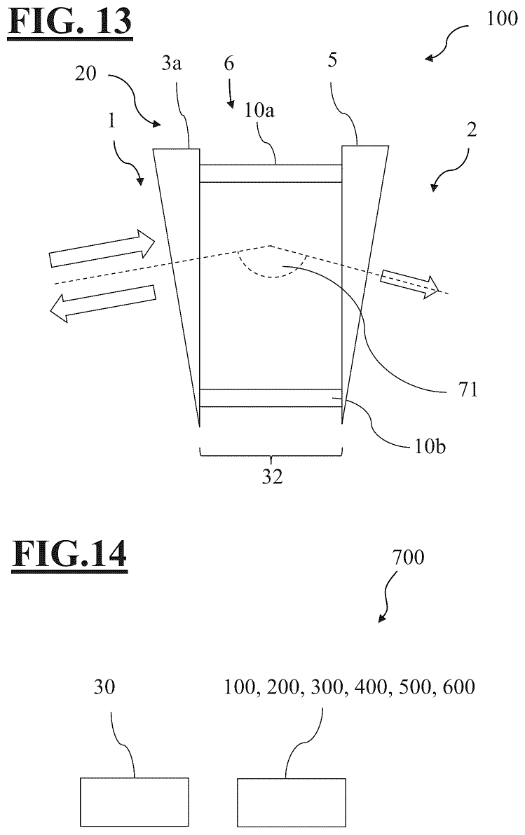

FIG. 13 shows a schematic illustration of a device (100) for setting an optical transmission according to a further embodiment. The illustrated embodiment has the same properties as the already described embodiment in FIG. 1, wherein, unlike in FIG. 1, the shape of the first and the second optical element (3a, 5) in the embodiment shown in FIG. 13 is designed such that the direction of light incidence on the first side (1) differs from the direction of light emergence on the second side (2) by virtue of these elements having a triangular shape shown here in section. Depending on the characteristics of the triangular shape and the material of the first and the second optical element (3a, 5), the angle (71) between the direction of light incidence on the first side (1) and the direction of light emergence on the second side (2) can be set. To avoid repetition, reference is made to the explanations in relation to the previous exemplary embodiments, especially to the explanations in relation to FIGS. 1 and 3 to 6.

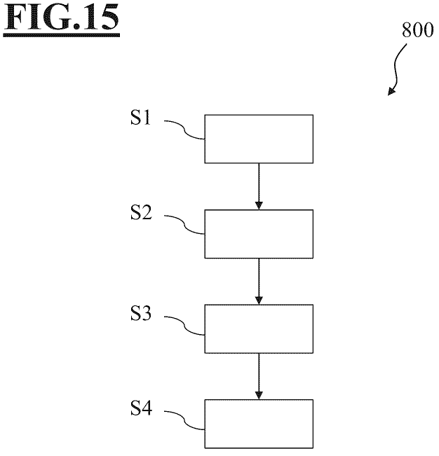

FIG. 14 shows a schematic structure of a system 700 having a light source 30 and a device 100, 200, 300, 400, 500, 600. The light source 30 can be an excimer laser beam source, which emits light at a wavelength of 193 nm. Other radiation sources are possible, wherein the device 100, 200, 300, 400, 500, 600 is set to the corresponding radiation source. The device 100, 200, 300, 400, 500, 600 is arranged in the beam path from the light source 30 such that the light emitted from the light source 30 is able to enter the device 100, 200, 300, 400, 500, 600 on the first side 1 of the device 100, 200, 300, 400, 500, 600. The device 100, 200, 300, 400, 500, 600 is designed accordingly to set the light to be transmitted from the light source 30, which can emerge on the second side of the device 100, 200, 300, 400, 500, 600, via a movement of the at least first optical element 3a; 3b; 3c.

The device 100, 200, 300, 400, 500 can further be designed to substantially keep constant a light intensity value reflected into the light source 30 by the device 100, 200, 300, 400, 500. To this end, the device comprises corresponding sensors and control mechanism, as have already been explained above.

FIG. 15 shows a block diagram for illustrating the method 800 for setting an optical transmission of a device 100, 200, 300, 400, 500, 600. In this case, the method 800 comprises measuring S1 a light intensity value on the second side 2 of the device 100, 200, 300, 400, 500, 600, comparing S2 the measured light intensity value on the second side 2 of the device 100, 200, 300, 400, 500, 600 with a predetermined light intensity target value, determining S3 a target position of the at least first optical element 3a, 3b, 3c depending on the comparison of the measured light intensity value and the predetermined light intensity target value, and adapting S4 an actual position of the at least first optical element 3a, 3b, 3c to the determined target position of the at least first optical element 3a, 3b, 3c via the adjustment mechanism 6 such that the measured light intensity value corresponds to the predetermined light intensity target value.

The target position of the at least first optical element 3a, 3b, 3c can also comprise a relative position of a first and a second optical element.

Measuring S1 a light intensity value on the second side 2 of the device 100, 200, 300, 400, 500, 600 can be implemented via a first sensor 21 for capturing transmitted light on the second side 2. Furthermore, the steps of comparing S2, determining S3 and adapting S4 can be implemented via the control unit 22 signal-connected to the adjustment mechanism 6 and the first sensor 21, by virtue of corresponding signals being transmitted from the first sensor 21 to the control unit 22 and control signals being transmitted from the control unit 22 to the adjustment mechanism 6.

The method can additionally comprise (and not shown) measuring S5 a light intensity value of reflected light on the first side 1 of the device 100, 200, 300, 400, 500 via the second sensor 24 signal-connected to the control unit 22, the control unit 22 controlling the adjustment mechanism 6 in such a way that a reflected light intensity on the first side 1 is kept constant. Wherein the method can further comprise (not shown in FIG. 15) reducing S6 the transmitted light intensity on the second side 2 via a variable absorber 16 such that the measured light intensity value on the second side 2 corresponds to the predetermined light intensity target value.

Certain illustrations and embodiments in the figures, which were related to an embodiment variant with one or two optical elements 3a, 3b, 3c, 5, with or without absorber 16 and with or without control unit 22, sensors 21, 24 and signal connections 23, are not restricted only to the respective embodiment variant; instead, they can be combined with one another such that different embodiments of the optical elements 3a, 3b, 3c, 5, absorber 16, control unit 22, sensors 21, 24 and signal connections 23 can be combined with one another.

Although the disclosure has been described with reference to certain exemplary embodiments, it is apparent to a person skilled in the art that various modifications can be made, and equivalents can be used as a substitute without departing from the scope of the disclosure. Consequently, the disclosure should not be restricted to the disclosed exemplary embodiments but should comprise all exemplary embodiments that fall within the scope of the appended claims. For example, the disclosure also claims protection for the subject matter and the features of the dependent claims, irrespective of the claims referred to.

The present disclosure has been described above on the basis of specific exemplary embodiments showing specific combinations of the features defined in the following patent claims. It should expressly be pointed out at this juncture that the subject matter of the present disclosure is not restricted to these combinations of features, rather all other combinations of features such as are evident from the following patent claims also belong to the subject matter of the present disclosure.

### LIST OF REFERENCE SIGNS

1 First side
2 Second side
3a, 3b, 3c First optical element
5 Second optical element
6 Adjustment mechanism
8 Axis of rotation
9 Longitudinal axis
10a, 10b Piezo actuator
11a, 11b Piezo actuator
12 First effective direction
13 Second effective direction
14 Angle
16 Absorber
18, 19 Tilt axis
20 Optical component
21 First sensor
22 Control unit
23 Signal connection
24 Second sensor
25 Adjustment mechanism
30 Light source
32 Spacing
33 Transmission
34 Reflectivity
35 Relative transmission or reflectivity
36 Relative spacing of the first and second optical element depending on the wavelength
37 Physical extent of an optical element
38 Reflectivity or transmission
39 Location-dependent transmission curve
40 Angle
41 Light loss
43 Receptacle
44 Region of high transmission
45 Region of low transmission
46 Region of minimum absorption
47 Region of maximum absorption
71 Angle
100, 200, 300, 400, 500, 600 Device
700 System
800 Method

What is claimed is:

1. A device, comprising:
a first side;
a second side;
an optical component between the first and second sides, the optical component comprising a first optical element; and
an adjustment mechanism configured to move at least the first optical element to modify a transmission of the optical component to set a light intensity on the second side,
wherein the adjustment mechanism is configured to move at least the first optical element to adapt the optical transmission with a switching time of less than one second.

2. The device of claim 1, wherein the first optical element has a variable transmission.

3. The device of claim 2, wherein the first optical element has the shape of a circular disk with a variable transmission, the first optical element has the shape of a polygon.

4. The device of claim 1, wherein the first optical element has the shape of a circular disk with a variable transmission, the adjustment mechanism is configured to rotate the first optical element such that an axis of rotation of the first optical element is parallel to a longitudinal axis of the device.

5. The device of claim 1, wherein the optical component further comprises a second optical element, and the adjustment mechanism is configured to move the first optical element and the second optical element relative to each other.

6. The device of claim 5, wherein the relative movement of the first and the second optical elements comprises an opposite tilt of the first and the second optical element.

7. The device of claim 5, wherein the adjustment mechanism comprises a first group of piezo actuators configured to align the first and the second optical element plane-parallel to each other.

8. The device of claim 6, wherein the adjustment mechanism comprises a second group of piezo actuators configured to adapt a spacing of the first and the second optical element relative to each other to maintain an alignment of the first and the second optical element relative to each other.

9. The device of claim 8, wherein:
the first optical element is secured to a receptacle via the first group of piezo actuators, and the second optical element is secured to the receptacle via the second group of piezo actuators; or
the first optical element and the second optical element are movably connected to each other via the first group of piezo actuators and the second group of piezo actuators.

10. The device of claim 8, wherein the piezo actuators of the first group have a first effective direction, the piezo actuators of the second group have a second effective direction different from the first effective direction, and the first and second effective directions define an angle relative to each other so that a relative change in the spacing of the first and the second optical element depends on the angle.

11. The device of claim 8, wherein the piezo actuators of the second group comprise crystal oscillators.

12. The device of claim 8, wherein the piezo actuators of the second group are configured to perform a multiplicity of changes in spacing.

13. The device of claim 1, further comprising a variable absorber on the second side.

14. The device of claim 1, wherein a surface of the first optical element comprises a coating.

15. The device of claim 1, further comprising:
a first sensor on the second side, the first sensor configured to capture transmitted light on the second side; and
a control unit configured to control the adjustment mechanism,
wherein the control unit is signal-connected to the first sensor and the adjustment mechanism.

16. The device of claim 15, further comprising a second sensor on the first side, wherein the second sensor is signal-connected to the control unit, and the second sensor is configured to capture light on the first side reflected by the device.

17. A system, comprising:
a light source configured to emit light in a beam path; and
a device according to claim 1,
wherein the device is in the beam path so that the light emitted from the light source enters the device on the first side, and the device is configured so that movement of at least the first optical element sets light transmitted from the light source that emerges on the second side of the device.

18. A system of claim 17, wherein the light source comprises a laser beam source.

19. The system of claim 17, wherein the device is configured so that the optical element reflects at least some light from the light source that enters the device at the first side back into the light source via the first side.

20. A method, comprising:
providing a device according to claim 1; and
setting an optical transmission of the device by a process comprising:
measuring a light intensity value on the second side;
comparing the measured light intensity value on the second side to a predetermined light intensity target value;
determining a target position of the at least first optical element based on the comparison of the measured light intensity value and the predetermined light intensity target value; and
adapting an actual position of the at least first optical element to the determined target position of the at least first optical element using the adjustment mechanism so that the measured light intensity value corresponds to the predetermined light intensity target value.
